(19) United States
(12) Patent Application Publication
(10) Pub. No.: US 2007/0174299 A1
(43) Pub. Date: Jul. 26, 2007

(54) Mobile device / system

(76) Inventors: Shaobo Kuang, Lansdale, PA (US); Yinan Kuang, Lansdale, PA (US)

Correspondence Address: Shaobo Kuang, 1243 Meadowview Circle, Lansdale, PA, 19446, US

(21) Appl. No.: 11/647,495

(22) Filed: Dec. 29, 2006

Related U.S. Application Data
(60) Provisional application No. 60/757,491, filed on Jan. 10, 2006.

(51) Int. Cl. G06F 17/30

(52) U.S. Cl. 707/10

(57) ABSTRACT

This invention relates generally to techniques for searching or querying information from a small mobile device, such as a cellphone or blackberry. People holding a small hand-held device, like cellphone or blackberry, don't want to type or enter many words to search/query. However, they want the most accurate information from the search results. Present invention allows the small mobile devices, like cellphone or blackberry, to automatically build the real time location/position information into the search/query string so that the users don't need to enter their location/position information when they enter their search/query string. Also, according to the present invention, search engine not only returns the search results, but also the structures of the categories of the results so that the client devices can further search within the search results without connecting back to the search engine hosts. Users just need to move the cursor up or down on the pull-down menu or a selection list of the categories of the search results to further search within the search results.

Part of the present invention is based on the provisional Patent Application, Ser. No. 60/757,491, filed on Jan. 10, 2006, titled “Mobile device/System”

### FIELD OF THE INVENTION

This invention relates generally to techniques for searching/query on a small mobile device, like cellphone or blackberry. More particularly, it relates to methods and systems for obtaining/showing/handling the real time current location in a small mobile device, such as a cellphone or blackberry, and also relates to methods and systems for Internet searching or querying on a small mobile device, such as a cellphone or blackberry.

### BACKGROUND OF THE INVENTION

Due to the developments in mobile device technology, like 3G, and its increase in popularity, large numbers of people have recently started to use cellphones, or the other mobile devices to search for information or for people. However, people still use computers to search or browse for almost everything from web. Due to a mobile device's small screen and small keypad, people usually only search from the mobile device when they really need the information right away. For example, people need to look for weather/restaurant/hotel information when they are traveling or in a new place. Most search engines, like Yahoo or Google, provide local searches. In Yahoo's local search page, the user enters the search keyword, such as “restaurants” in an input field/box, and then enters the address information, such as address, city & state, or zip code in another input field/box, and clicks the submit button to send the information. Yahoo then returns a result page with a list of the found restaurants near by the given location. The list can be ordered by distance, name, or rating. Some pages even show the real distance, such as 0.35 miles. In Google's local search page, the user will enter the keyword, such as “restaurants” and address information in the search field/box. Google will then provide the user with a list of restaurants near the area. Most search engines are capable of making a cache of one's preferred location, such as home address or work address, or allow the user to set up a profile. Therefore, the next time the user performs a search, his or her default address information will be automatically shown in the address input field/box. On the desktop, performing a local search is usually very convenient because the user can type in the keyword and location very quickly and he or she probably knows the location information. On the cellphone, however, performing a local search can be very difficult because it is not easy to type many letters on the small device. In addition, most people search the Internet through a cellphone while traveling. Usually, they will not know the exact address where they are. Different search engines require different query strings. For example, a Yahoo local search query string can be “csz=Lansdale+PA+19446” while a Google local search query string can different. This causes inconveniences when the user tries to use a different search engine. Currently, the prior art provides no solution to solve the above issues. Most people do not prefer using a cellphone to performing an Internet search. Recently, some cellphones come with a built-in GPS system. However, a GPS system is very expensive, and not many people can afford it. Also, GPS has it's own dedicated system, and it usually does not talk to the search engines directly. Another drawback is that a small handheld device, like a cellphone or blackberry, will constantly shift directions as the user moves. This will cause the user difficulty in determining the right directions.

When people search or query information from PC or laptop, usually they type the primary key words first, for example, Movie in New York City. Then, after they get a result list, they will search within results, and enter the secondary key words, for example, Action, and get a narrowed result list. They will continue do this until they get a satisfied search/query results. However, in a small device like cellphone or blackberry, this kind of search will cause many forth and back searches/queries from cellphones to search engine hosts, and force people to type/enter more stuff in their small devices. That is why most people don't like to search/query on a small device like cellphone or blackberry.

When doing search on a small hand-held device, like cellphone or blackberry, people don't want to type or enter so many key words, such as their locations or the detailed categories for what they are searching. When doing searches on small hand-held devices, like cellphones or blackberries, people want more accurate search results, such as the restaurants in a particular location, and the a special style of the restaurants. However, the current searching technology requires an inconvenient amount of entries or typing on a small mobile device, like cellphone or blackberry, in order to get more accurate search results.

### SUMMARY OF THE INVENTION

It is therefore the objects of the present invention are intended to overcome the drawbacks of the conventional art:

Accordingly, an object of the present invention is to provide a method and system/device which allows the user to easily to enter his or her location information when making a query to the host from a small mobile device like cellphone or blackberry.

Another object of the present invention is to provide a method and system/device which allows the user to easy to enter his or her real time location information when making a query to the host.

Another object of the present invention is to provide a method and system/device which allows the user to send a query with location information to the host without typing in or enter the location information.

Another object of the present invention is to provide a method and system/device which allows the user to send a query to the host without knowledge of his or her present location.

Another object of the present invention is to provide a method and system/device which allows the user to gain knowledge of which direction his or her destination is.

Another object of the present invention is to provide a method and system/device which allows the host to send the results page with the distance and direction information back to the user.

Another object of the present invention is to provide a method and system/device which is capable of showing the user the results page graphically displaying the direction of the destination.

Another object of the present invention is to provide a method and system/device which is capable of showing the user the results page with the directions of the destination dynamically changing as the cellphone changes directions.

Another object of the present invention is to provide a method and system/device which is capable of sending the caller's real time location information to certain receivers of his or her calls, such as 911, 411, or local police, ambulance, or fire departments.

Another object of the present invention is to provide a method and system/device which is capable of showing the user the direction of his or her destination.

Another object of the present invention is to provide a method and system/device which is capable of showing the user direction graphically for each item on the search result page.

Another object of the present invention is to provide a method and a system/device which allow people to type/enter less words in their small devices, like cellphone or blackberry, and get their satisfied search results.

Another object of the present invention is to provide a method and a system/device which allow the client devices can process or search within the search results without talk or connect back the search engine hosts.

Another object of the present invention is to provide a method and a system/device which allow the users further search within the search results in off-line mode.

Another object of the present invention is to provide a method and a system/device which allow the people do the most search/query just by moving cursor up or down on a pull-down menu or a selection list without type or enter the key words in their small devices, like cellphone or blackberry devices.

Further objects and advantages of our invention will become apparent from a consideration of the drawings and ensuring description.

A mobile system according to the present invention includes:
one or more mobile devices;
one or more carrier systems, which transfer the signal from one said mobile device to another mobile device;
wherein the said mobile devices further include means for obtaining the real time location of the mobile devices, and inserting/merging the said real time location information into the user's query strings, and send them together to a search engine when the users perform a search/query on Internet or the host.

A mobile system according to the present invention includes:
one or more mobile devices;
one or more carrier systems, which transfer the signal from one said mobile device to another mobile device;
wherein the said carrier systems further include means for obtaining the real time location of the mobile devices, and inserting/merging the said real time location information into the user's query strings, and sending them together to a search engine when the users perform a search/query on Internet or the host.

The said mobile device according to the present invention includes:
transmitter for sending signal;
receiver for receiving signal;
means for displaying the information;
wherein the mobile device further includes
   a compass for indicating the North or South direction on the said display screen;
   means for calculating the real time direction for each item on the search result page, and showing the direction for each item graphically.

An Internet searching system according to the present invention includes:
one or more search engine-hosts;
one or more mobile hand-held devices, like cellphones or blackberry devices,
the said searching host includes one or many search databases that hold the detail information, such as the URL, categories, and the descriptions relating to the user's queries,
wherein the said searching hosts further includes:
means for building the structures of the categories of the search results, inserting/merging the structures of the categories into the search results, and send categories structures together with the search results back to the said mobile devices;
wherein the said mobile hand-held devices, which include means for sending signal, means for receiving signal and means for displaying the information, further include:
means for extracting the categories information from the search results page, and allow the users further search within the search results based on the extracted categories.

### BRIEF DESCRIPTIONS OF THE DRAWINGS

FIG. 1A is a schematic drawing showing the architecture of the cellphone, carrier network, and search engine of the prior art system.

FIG. 1B is a schematic drawing showing the architecture of the cellphone, carrier network, and search engine of the present invention.

FIG. 1C is a schematic drawing showing the architecture of the cellphone, carrier network, and search engine of the present invention.

FIG. 2A is a schematic drawing showing an example of a search engine of the prior art.

FIG. 2B is a schematic drawing showing an example of a search engine of the present invention.

FIG. 3A is a schematic drawing showing an example of a local search results page of the prior art.

FIG. 3B is a schematic drawing showing an example of a local search results page of the present invention.

FIG. 4 is a schematic drawing showing the relationship between cellphones, carriers, and universal location codes of the present invention.

FIG. 5A is a schematic drawing showing the architecture of the cellphone system of the present invention.

FIG. 5B is a flow chart showing how the directions of example destinations would be calculated.

FIG. 5C is a schematic drawing showing an example of a search results page and how the direction arrows would change according to the cellphone's position.

FIG. 5D is a schematic drawing showing an example of a map and how it would change according to the cellphone's position.

FIG. 6 is a schematic drawing showing a certain receiver getting the real time location of the calling cellphone.

FIG. 7A is a schematic drawing showing the architecture of Internet searching in prior art.

FIG. 7B shows an example of the detail part codes in a searching results page of prior art.

FIG. 7C shows an example of a searching results page layout of the prior art.

FIG. 8A is a schematic drawing showing the architecture of Internet searching in the present invention.

FIG. 8B shows an example of the detail part codes in a searching results page of the present invention.

FIG. 8C shows an example of a searching results page layout of the present invention.

### DETAILED DESCRIPTION OF THE INVENTION

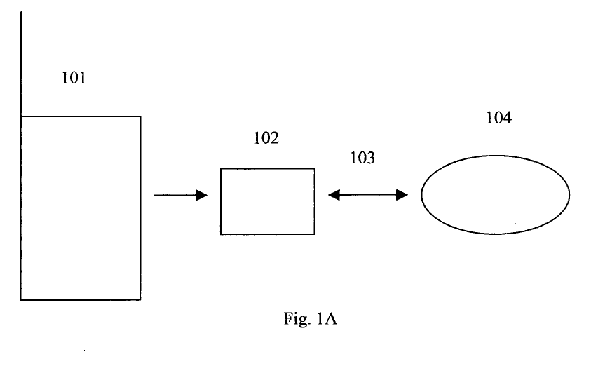

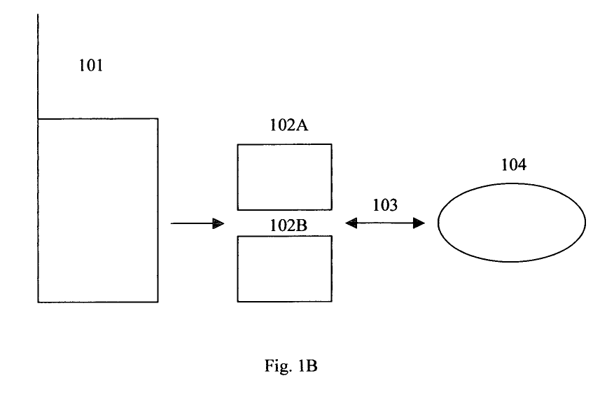

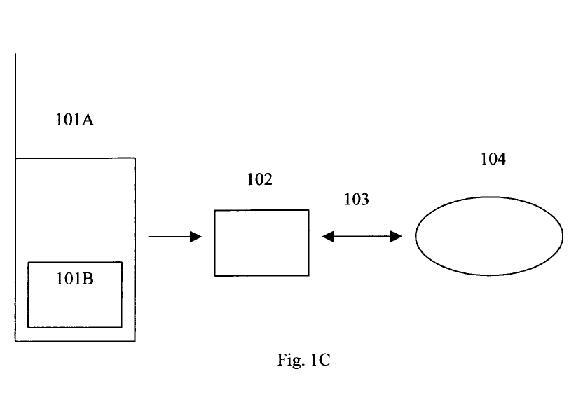

Referring now to the drawings, FIG. 1A shows the architecture of the cellphone or the other mobile device, carrier network, and search engine of the prior art system. In this example, 101 is the cellphone, 102 is the carrier, 103 is the Internet network, and 104 is the search engine. When the user tries to connect to the Internet, the cellphone first connects to the carrier equipment/host wirelessly. Then, the carrier connects the user to the Internet.

FIG. 1B shows the architecture of the cellphone or the other mobile device, carrier network, and search engine of the present invention. In this example, 101 is a cellphone or another mobile device, 102A is the carrier, 102B is a device/system for obtaining the real time location of the caller, and joining the real time location with the user's query string when submitting the user's query to a search engine, 103 is the internet network, and 104 is the search engine. When the user tries to connect to the Internet, the cellphone first connects to the carrier equipment/host wirelessly. Then, the carrier connects the user to the Internet. When the user conducts a local search, the system 102B automatically joins the user's query string and the real time location information, and submits them to the search engine. For example, the user performs a query like “keyword=restaurant”. 102B will obtain user's real time location like zip=12345, and, then, automatically join them together into a final query string, “keyword=restaurant&rtl=12345”, to the search engine. Therefore, the user can perform a local search without typing in his or her location information on the cell phone. Most people don't like entering many letters/characters into a small device like a cell phone or other mobile device. Usually, when the user tries to perform a search, he or she doesn't know his or her exact location. The present invention provides a solution to solve prior art issues. In this example, the real time location (rtl) is preferred in a universal format/protocol. In this case, different cell phones or mobile devices, different carriers in different places or different countries, different systems, like CDMA or GSM, and different search engines are all in the same page. The current technology will definitely ensure the system to get a more detailed location/position information so that the search engines can, based on the detail location/position information, return the more accurate location/position information regarding the each found items. They also can tell you the directions, like NW (North West), for the places of your search.

FIG. 1C shows the architecture of the cellphone or the mobile device, carrier network, and search engine of the present invention. In this example, 101A is a cellphone or the other mobile device, 101B is a device/system integrated into the cellphone 101A that obtains/stores the real time location information of the user, 102 is the carrier, 103 is the internet network, and 104 is the search engine. When the user tries to connect to the Internet, the cellphone first connects to the carrier equipment/host wirelessly. 101B periodically obtains the real time location of the user from the carrier or the other system like GPS, and stores the real time location. When the user conducts a local search, the device 101B automatically joins user's query string and the real time location information into the final query string, and submit it to the search engine. For example, the user performs a query like “keyword=shopping mall”. The 101B will obtain user's real time location like zip=new york city, and, then, automatically join them together into a final query string, “keyword=shopping mall&rtl=new york city”, to the search engine. Therefore, the user can perform a local search without typing in his or her location information on the cell phone. Most people don't like entering many letters/characters into a small device like a cell phone or other mobile device. Usually, when the user tries to perform a search, he or she doesn't know his or her exact location. The present invention provides a solution to solve prior art issues. In this example, the real time location (rtl) is preferred in a universal format/protocol. In this case, different cell phones or mobile devices, different carriers in different places or different countries, different systems, like CDMA or GSM, and different search engines are all in the same page. If the cellphone has the built-in GPS system, 102B will convert the GPS location information to a universal real time location code/format/protocol, and join the real time location with the user's query together, and submit it to the search engine. The current technology will definitely ensure the system to get a more detailed location/position information so that the search engines can, based on the detail location/position information, return the more accurate location/position information regarding the each found items. They also can tell you the directions, like NW (North West), for the places of your search.

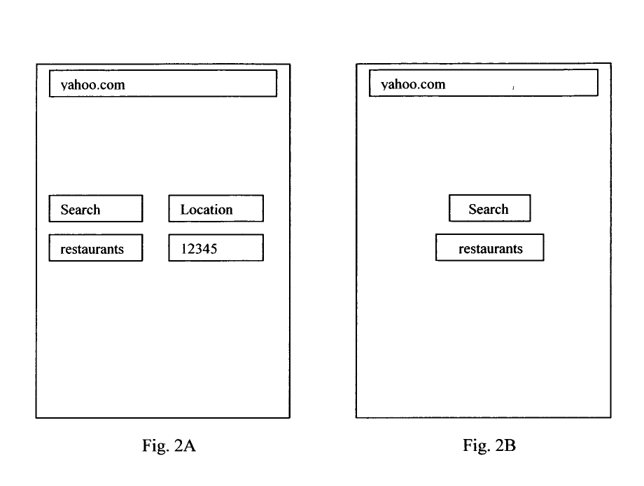

FIG. 2A shows an example of the prior art Yahoo local search engine page. The user types in the keyword search into the “search” input field/box and the location information into the “location” input field/box. In this example, the user types in “restaurants” into the search field/box, “12345” into the location input field/box.

FIG. 2B shows an example of a local search engine page of the present invention. The user only needs to type in the keyword search into the “search” input field/box. Since the cellphone or the other mobile device, according to the present invention, will automatically obtain the real time location of the user, join the user's query string and the real time location into the final query string, and submit it to the search engine, the user doesn't need to type anything into the cellphone for the location.

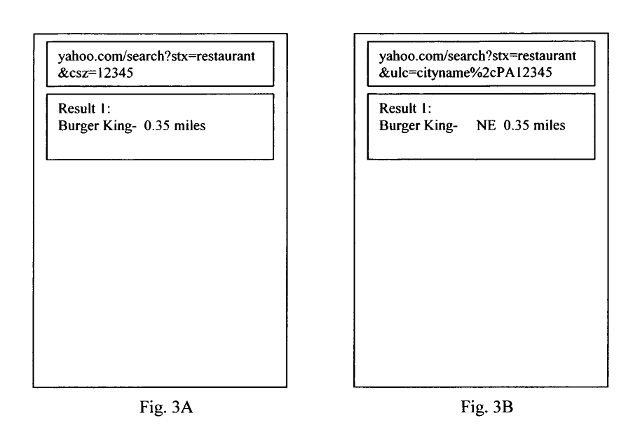

FIG. 3A shows an example of a traditional local search results page. After each result, the page displays its name and distance from the location entered.

FIG. 3B shows an example of the local search results page of the present invention. Since according to the present invention, the mobile system/device will automatically send a more detailed location/position information to the search engines, the search engines are able to tell the user the directions of each item on the search result page. For each result, the page displays its name, the direction of the destination, and its distance from the real time location.

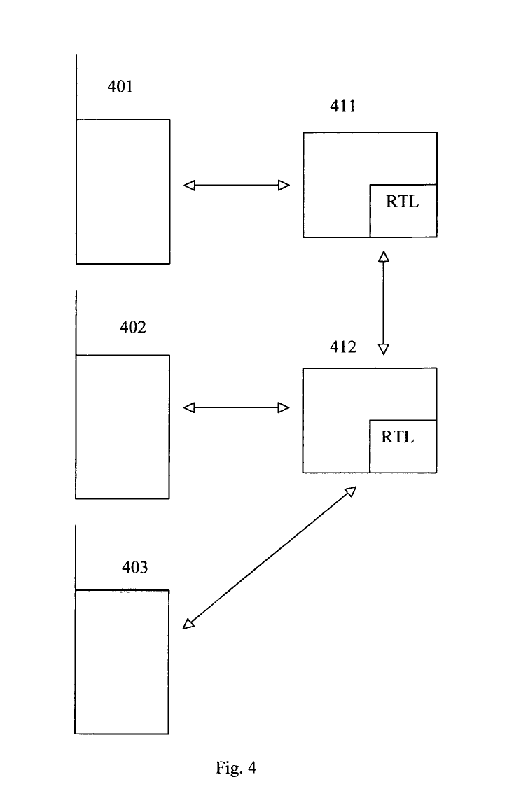

FIG. 4 shows an example of the architecture of three cellphones and two carriers. 401 is a cellphone or regular phone, 402 is a cellphone or regular phone, and 403 is a cellphone or regular phone. 411 is the first carrier and 412 is the second carrier. 401 is assigned to 411 and 402 and 403 are assigned to 412. Each carrier has an integrated system that determines each cellphone's real time location information. Since, according to the present invention, each system 401/411, and 402/403/412, uses a universal real time location, then 401, 402 and 403 are able to tell each other their real time location. If the user of cellphone user travel to other place, or even country, the cellphone may talk to the local carrier first, and then the local carrier transfer the call to the user's carrier. This is so called roaming. Therefore, it is preferred that the real time location used by the carriers/cellphones/search engines is in the same definition, such as the same format, the same protocol so that there is no problem/issue, no converting needed among carriers/cellphones/search engines or the other systems.

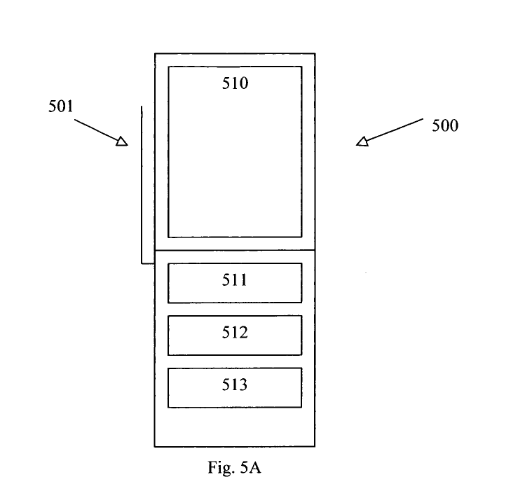

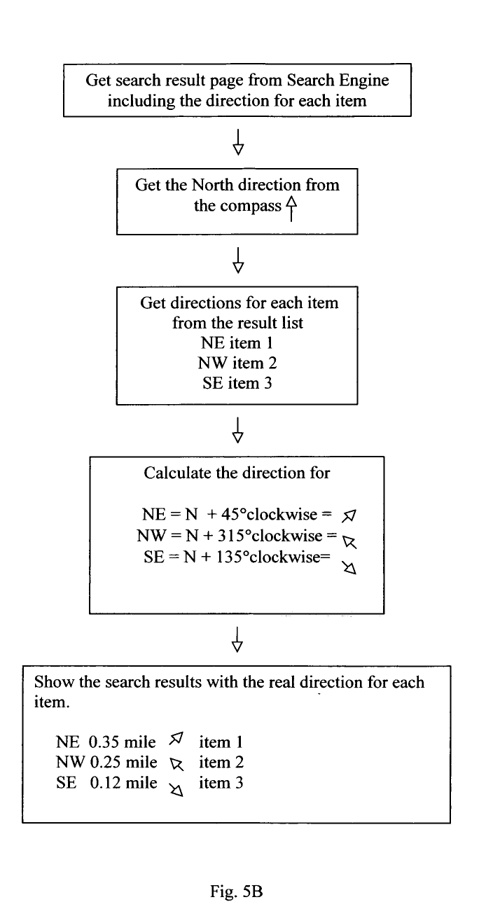

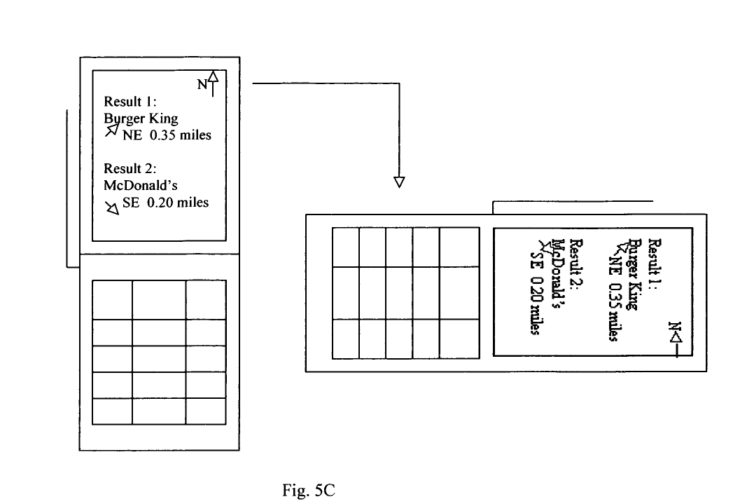

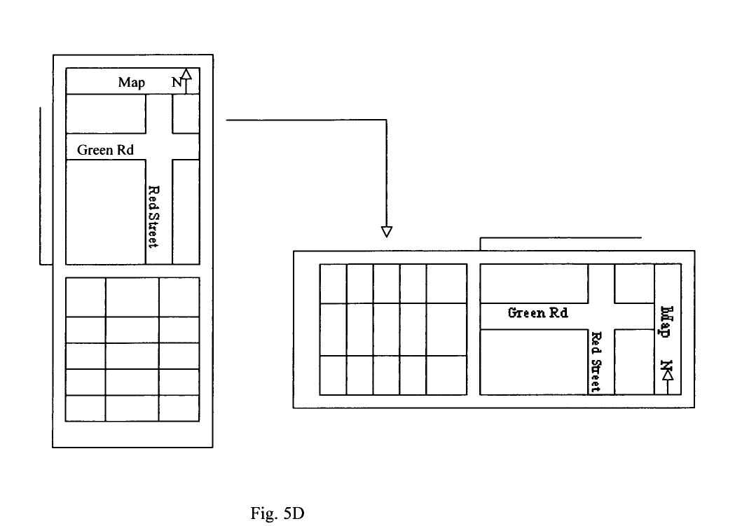

FIG. 5A is a schematic drawing showing the architecture of the cellphone system of the present invention. In this example, 500 is the cellphone, 501 is the antenna, 510 is the display screen, 511 is the other cellphone components, 512 is a built-in compass, which is preferred an electronic compass, and 513 is a direction indicator/calculator, which can read the direction information, such as North, from the electronic compass 512, and then calculate which direction is NW, NE, SE, SW, and so on, and shows an indicator, like an arrow, on the screen graphically. After submitting a search query, the user gets a result page with many found items from a search engine. Since, according to the present invention, the mobile system automatically sends the more detailed real time location with the user's query to the search, the search engines are able to return the found items with distance and direction information. The 513, direction indicator/calculator will, based on the direction from the compass 512, calculate the real time direction for each item on the search result page and show a real time graphic arrow telling the user the direction of each item. When the user moves the cellphone, the direction arrow will move too, so that the direction arrows will always show the correct direction for each found item on the search result page. For example, the source for each item in the search result page may be like this:
<direction>NE</direction>
<a href=“getmap.asp”>0.12 mile Burger King restaurant</a>

The system, like browser in cellphone or mobile device, will pass the information between the direction tag, NE, to the 513, direction indicator/calculator. 513 will calculate the real time direction for Burger King restaurant, and will show an arrow in front of NE, indicating the real time direction of the found Burger King. The arrows may change the direction while the user moves/shift the cellphone. Although, in this example, it shows an arrow indicating the direction, it can be apply to other things, such as a map. In this case, the direction indicator/calculator 513 will check compass 512 first, and the direction of North, and then based the North direction of the map, rotate the map to match the real direction. Therefore, every time the user looks at the map, it will always show the user the map in right direction. The user doesn't need to adjust/rotate the cellphone to get the right/correct direction for map.

FIG. 5B shows the steps to how the cellphone would calculate the direction of the user's destination relative to his or her location. After receiving the results from the search engine, the electric compass inside the cellphone will determine the direction of north. The search engine would then send the directions of the results relative to the user's real time location. A device integrated into the cellphone would calculate the arrow direction of the results by performing the following calculation: Direction of North+_°clockwise. The number of degrees clockwise depends on the direction of the destination sent from the search engine. The cellphone then displays the arrows according to the calculation.

FIG. 5C shows an example of the dynamically changing direction arrows. As the cellphone changes angles, the arrows of the north direction and destination directions stay fixed. Therefore, the mobile device/cellphone always shows the user the arrows indicating the correct directions as the user moves or shifts the cellphone. Although it doesn't show the compass arrow/direction, it may display an arrow on the top the result page always indicating North.

FIG. 5D shows an example of a dynamically changing/rotating map. As the cellphone changes angles, the direction of north and the map stay fixed. Therefore, the mobile device/cellphone always shows the user the map with correct directions as the user moves or shifts the cellphone.

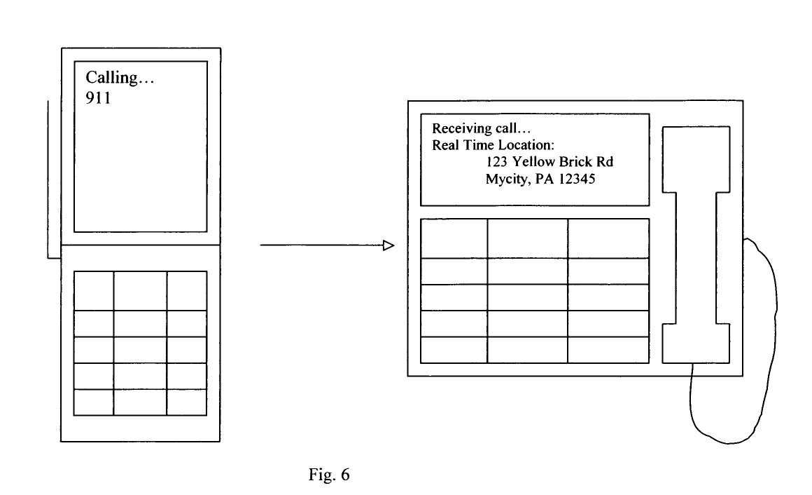

FIG. 6 shows an instance where a person would call from a cellphone to a certain number that would receive its real time location. The receiver, which is police office, gets the caller's exact or closest address including city, state, and zip code. In this case, the 102B (for obtaining the user's real time location), in FIG. 1B, further includes a predetermined list which stores a phone number list, such 911, 411, and other emergency phone number. When the user makes a call. 102B in FIG. 1B will check the list first, and, if the receiver's phone number is in the predetermined list, then pass the caller's real time location to the receiver. Therefore, the receiver will see the call ID and the real time location information on his screen. This is especially useful for some emergency number, like 911. This will allow police people more accurate find/locate the people who need an emergency help.

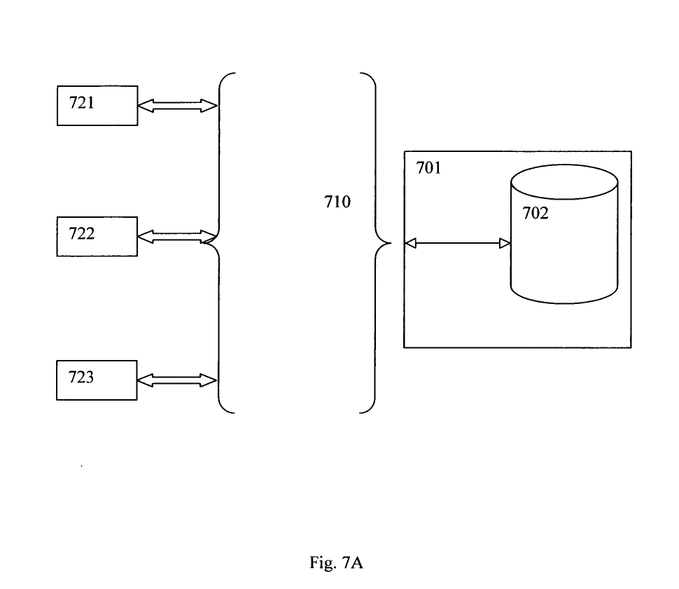

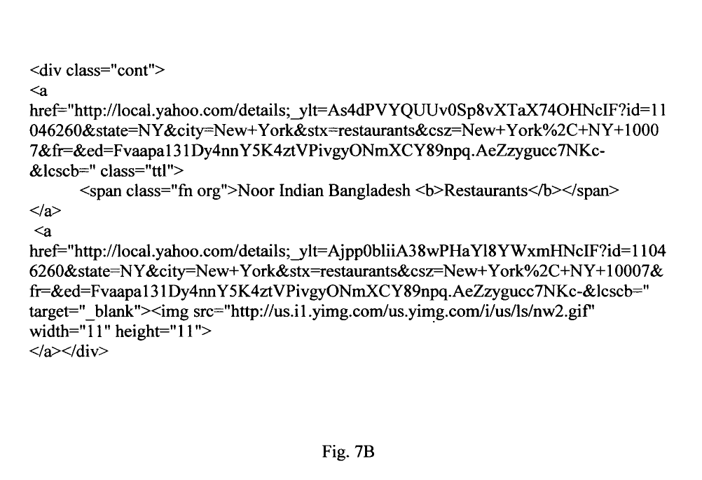

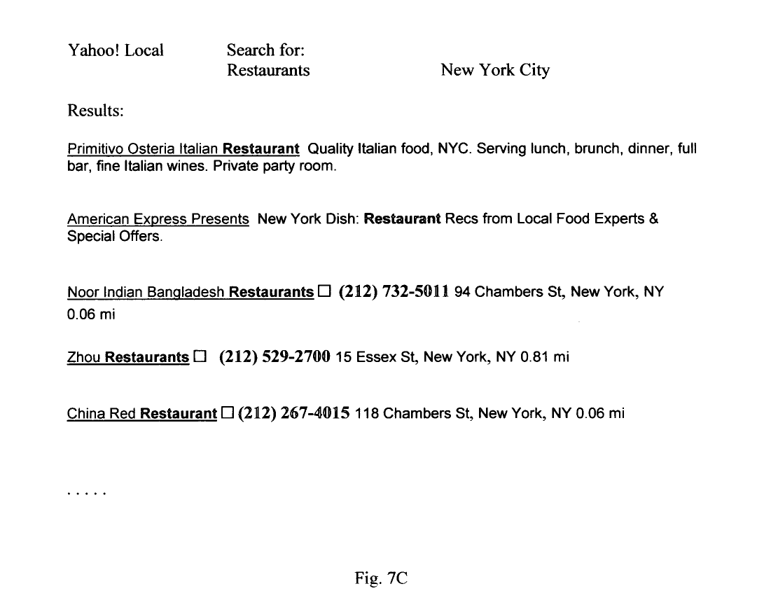

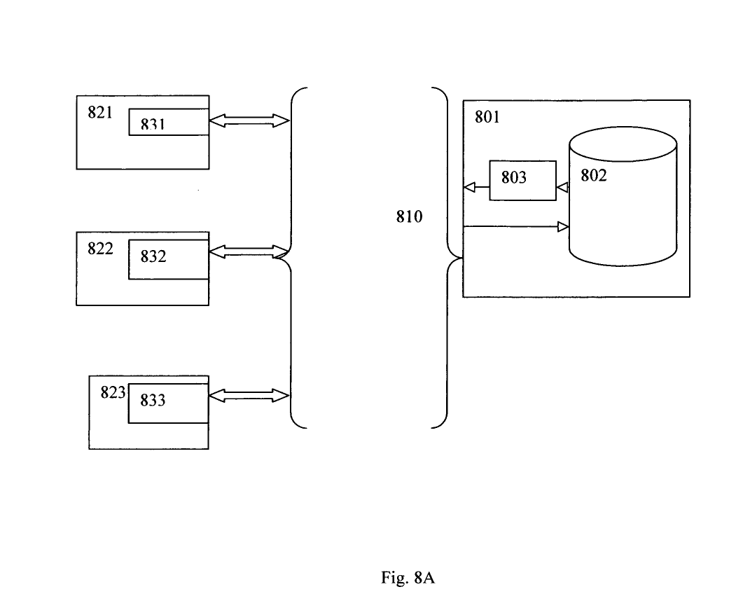

FIG. 7A schematically shows the architecture of Internet searching in prior art. 701 is a search engine host which include an information database/storage 702. Mobile devices, like cellphone or blackberry type devices 721, 722, and 723 (Of course, they can be regular computers or laptops) are connected to the search engine 701 through Internet 710. When searching, the users of the mobile devices enter or type the query key words in the mobile devices 721, 722 or 723. The mobile devices send the queries to the search engine 701 through the Internet connection 710. The search engine 710 will look in its database 702 and find out the information/records matching the queries, and send a result page with the matched information/records back to the mobile devices through Internet. The devices, then, display the results page to the users from the display screen in the mobile devices.

FIG. 7B shows an example of the detail codes in a prior art search results page, which is a typical html page.

FIG. 7C shows an example of the prior art layout of a search results page, which lists hyper links and their descriptions. Users will get to the target page by click on the related hyper links on the results page.

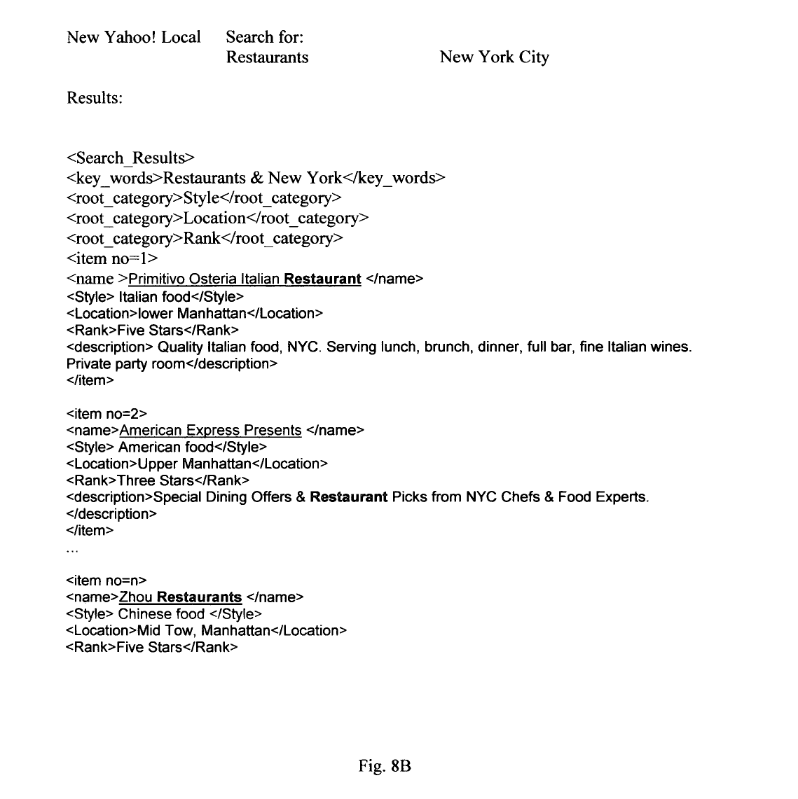

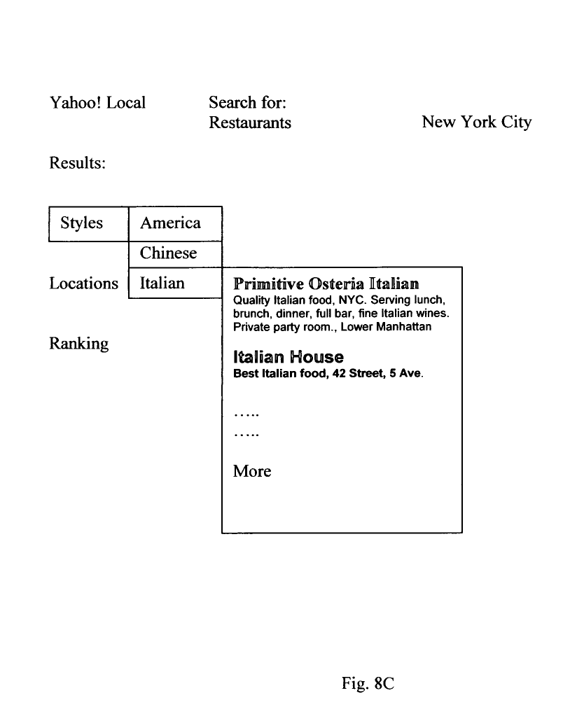

FIG. 8A schematically shows the architecture of Internet searching according to the present invention. 801 is a search engine host which include an information database/storage 802. 802 stores the indexed massive information about the millions web pages, such as URL, names, descriptions, categories, ranks, geographies, nations, languages, and etc. 801 further includes a device/system 803 for building the structures, like hierarchy structures, of the categories, and merging the categories structures into the search results page. Mobile devices, like cellphone or blackberry type devices 821, 822, and 823 (Of course, they can be regular computers or laptops too) are connected to the search engine 801 through Internet. 810. 821, 822 and 823 further include a system 831, 832, and 833 for extracting the above mentioned category structures from the search results, and shows the structures of the categories in the search results page. When searching, the users of the mobile devices enter or type the query key words in the mobile devices 821, 822 or 823. The mobile devices send the queries to the search engine 801 through the Internet connection 810. The search engine 810 will look in its database 802 and find out the information/records matching the queries, 803 builds the structures for the categories of the results records and merge the categories structures into the search results. Then, 801 send the result page with the matched information/records and the categories structures back to the mobile devices 821, 822, and 823 through Internet. The systems 831, 832, 833 in the mobile devices extract the structures of the categories, and display the structures of the categories and the categorized results in the search results page on the display screen of the mobile devices. The structures of the categories can be displayed in a pull-down menu or a selection list so that the users can further move cursor up or down to further select within the search results. The system 831, 832 and 833 control the display list based on the users further selection. It only displays the records belongs to the user selected category in the search results. Therefore, the users are able to further search within the results without connect to the search engine host again.

FIG. 8B shows an example of the detail codes in a present invention search results page, which is preferably an XML page. In this example, the hierarchy category structures are:
Style→American food/Italian food/Chinese food
Location→Low Manhattan/Upper Manhattan/Mid Town, Manhattan
Rank→Five Stars/Three Stars

Of course, the hierarchy structures can be in different formats or structures based on the search engine's designs.

FIG. 8C shows an example of the present invention layout of a search results page. The left side of the search results page shows a pull-down menu of the category structure tree. The right side of the search results page displays the results relating to user selected category from the category structure tree. In this example, the user move the cursor on “Style” and then move the cursor on to “Italian”, he gets a list of the Italian restaurants. In this example, the user only enter the key words ‘restaurants’ and the devices automatically send the real time location/position information to the search engine. The search engine returns a results list with the category structures. The mobile devices extract the category structures, and display the category structures in a pull-down menu. The user moves the cursor down to “Italian”, and the system displays all Italian restaurants in New York City on the screen of the mobile device, like cellphone or blackberry. If the user wants is not interested in the Italian restaurants in the display list, he can move the cursor to “More” to re-connect to search engine host to search or query with the new search/query string or key words “Italian restaurants & New York City”. Then he gets a search results page regarding “Italian restaurants in New York City” without typing or entering the key words “Italian” and “New York City”. Compared with the prior art, which requires the user to type or enter the key words “Italian” and “restaurants” and “New York City”, it only requires the user to type or enter the key word “restaurants”. In mobile searching, most likely, users will search something like restaurants, hotels, bars, movies, sports, or headline news. If users bookmark his frequent used search/query key words, like “restaurants” or “hotels”, according to the present invention, he is able to search/query without any typing or entering, just by moving cursor up or down on the pull-down menu or the selection lists. In this example, we search for ‘restaurants’. Of course, we can use this technology to search for some other things. For example, people go shopping in a shopping center in Manhattan, and want to search for shopping information. In this case, the search engines may return the search results page with shopping category structures, such as store names, discount rates, clothes, electronics, new promotions, shoes, brands, and etc. Another example is to select the target person to date. In this case, users just need to select/enter key words like “Dating”, the mobile system according to the present invention will show him or her a persons list with categories like male, female, friends, singles, professional, age 21-30, age 31-45, and etc.

Although the invention has been described with reference to the above-described embodiments and examples, it will be appreciated that many other variations, modifications, and applications may be devised in accordance with the broad principles of the invention disclosed herein. The invention, including the described embodiments and examples and all related variations, modifications and applications is defined in the following claims.

Therefore, the forgoing is considered as illustrative only of the principles of the invention. Furthermore, since numerous modifications and changes will readily occur to those skilled in the art, it is not desired to limit the invention to the exact construction and operation shown and described. Accordingly, all suitable modifications and equivalents may be resorted to, falling within the scope of the invention.

1. A mobile system according to the present invention includes:
one or more mobile devices;
one or more carrier systems, which transfer the signal from one said mobile device to another mobile device;
wherein the said mobile devices further include means for obtaining the real time location of the mobile devices, and inserting/merging the said real time location information into the user's query strings, and send them together to a search engine when the users perform a search/query on Internet or the host.

2. A mobile system according to claim 1, wherein the said mobile device, which includes means for sending signal, means for receiving signal and means for displaying the information, further includes:
a compass for indicating the North or South direction on the said display screen;
means for calculating the real time direction based on the relative direction information in the search results, and showing the relative direction for each item graphically.

3. A mobile system according to the present invention includes:
one or more mobile devices;
one or more carrier systems, which transfer the signal from one said mobile device to another mobile device;
wherein the said carrier systems further include means for obtaining the real time location of the mobile devices, and inserting/merging the said real time location information into the user's query strings, and sending them together to a search engine when the users perform a search/query on Internet or the host.

4. A mobile system according to claim 2, wherein the said mobile device, which includes means for sending signal, means for receiving signal and means for displaying the information, further includes:
a compass for indicating the North or South direction on the said display screen;
means for calculating the real time direction based on the relative direction information in the search results, and showing the relative direction for each item graphically.

5. An Internet searching system according to the present invention includes:
one or more search engine-hosts;
one or more mobile hand-held devices, like cellphones or blackberry devices,
the said searching host includes one or many search databases that hold the detail information, such as the URL, categories, and the descriptions relating to the user's queries,
wherein the said searching hosts further includes:
means for building the structures of the categories of the search results, inserting/merging the structures of the categories into the search results, and send categories structures together with the search results back to the said mobile devices.

6. An Internet search system according to claim 5, wherein the said mobile hand-held devices, which include means for sending signal, means for receiving signal and means for displaying the information, further include:
means for extracting the categories information from the search results page, and allow the users further search within the search results based on the extracted categories.

7. An Internet search system according to claim 6, wherein the said mobile device further includes means for re-arrange the display layout of the search results page based on the extracted categories when displaying the search results page on the displaying means.

8. An Internet search system according to claim 7, wherein the said mobile device further includes means for displaying a pull-down menu for the extracted categories structures, and allowing the user to move the cursor up or down to select the category to further search within the search results page without connecting to Internet again.

9. An Internet search system according to claim 8, where the said mobile devices further include means for displaying the records belongs to the category selected by the users from the searching results.
